(19) United States
(12) Patent Application Publication
(10) Pub. No.: US 2009/0305540 A1
(43) Pub. Date: Dec. 10, 2009

(54) Multi-polar connecting terminal

(75) Inventors: Hermann Stadler, Donaueschingen (DE); Oswald Mossinger, Konigsfeld-Neuhausen (DE)

Correspondence Address: THE NATH LAW GROUP, 112 South West Street, Alexandria, VA, 22314, US

(73) Assignee: MC TECHNOLOGY GmbH, Blumberg (DE)

(21) Appl. No.: 12/457,352

(22) Filed: Jun. 9, 2009

(30) Foreign Application Priority Data
Jun. 9, 2008 (DE) 10 2008 027 399.6

(51) Int. Cl. H01R 13/62

(52) U.S. Cl. 439/310

(57) ABSTRACT

The invention relates to a multi-polar connecting terminal (10, 10′), having a plurality of single-pole connecting terminal segments (20), each with a housing (21), such that the single-pole connecting terminal segments (20) can be joined together to form the multi-polar connecting terminal (10, 10′) by means of a plug-in or click-in connection (27, 28) positioned on the housings (21), and the housings (21) are glued together with an adhesive layer (40, 40′).

The invention relates to a multi-polar connecting terminal according to the preamble of claim 1.

The prior art is acquainted with multi-polar connecting terminals which are produced from a plurality of single-pole connecting terminal segments. These single-pole connecting terminal segments have a housing on which a plug-in or click-in connecting component is positioned, to thereby permit the connection of the housing to the multi-polar connecting terminal. These connections between connecting terminal segments are sufficient for ordinary usage. When there is a high mechanical load, e.g., as caused by manipulation upon insertion or in the case of a high thermal load, e.g., when there is reflow soldering with lead-free solders, connections of this kind may become slightly loosened, with the result that the connecting terminal is deformed and, in particular, is bent.

The goal of the invention, therefore, is to provide a multi-polar connecting terminal which is composed of a plurality of single-pole connecting terminal segments and which is able to withstand the mechanical or thermal load without deformation.

The goal of the invention is achieved by a multi-polar connecting terminal with the features of patent claim 1.

Advantageous embodiments and elaborations of the invention are indicated in the secondary claims.

The multi-polar connecting terminal according to the invention, which is composed of a plurality of single-pole connecting terminal segments, where the single-pole connecting terminal segments have a housing on which a plug-in or click-in connection is positioned in order to connect the connecting terminal segments to form the multi-polar connecting terminal, is characterized by the fact the housings of the connecting terminal segments are additionally glued together with an adhesive layer. The adhesive layer prevents the multi-polar connecting terminal from being deformed or bent when there is high mechanical or thermal load. In particular, the application of an adhesive layer is possible as a supplemental or subsequent measure, so that already known and employed multi-polar connecting terminals can be further improved, without the need to produce new connecting terminals.

In a preferred alternative the adhesive layer can be produced from a liquid adhesive, which is applied in a simple manner. In an alternative, preferred embodiment the adhesive layer is formed by an adhesive tape, particularly an adhesive tape made of fabric, which can glue together a plurality of connecting terminal segments along an external side of the connecting terminal, also in a simple manner.

It is particularly preferred if the adhesive layer is only applied to the outside of the connecting terminal, since in this manner an already assembled connecting terminal can be supplementally glued, without the need for the expensive step of applying adhesive between the individual connecting terminal segments.

The adhesive layer can be advantageously applied to the contact area between two bordering connecting terminal segments and thus only to the outside of the connecting terminal, since in this manner the individual connecting terminal segments can be reliably glued together with only a little glue.

It is particularly preferred if the adhesive layer is positioned continuously over an outside portion of the connecting terminal formed by the housing sides of the individual connecting terminal segments, since this permits all the connecting terminal segments to be reliably connected in a single production step.

According to a particularly preferred embodiment of the invention, each of the housings of the connecting terminal segments has a groove, and when the segments are connected to form the connecting terminal, the grooves collectively create a single groove running across the connecting terminal, so that the adhesive layer can be inserted into the groove. Thus the adhesive layer does not build up on the housing and, in particular, can be positioned in such a way that, after the adhesive layer hardens, there is a basically plane exterior surface.

It is particularly preferred if the adhesive layer uses a temperature-stable glue, so that deformation does not arise even when there is a high thermal load on the multi-polar connecting terminal.

The adhesive layer advantageously employs a UV-hardening glue, which is particularly suited for application to the outside of the connecting terminal, since an adhesive that hardens in visible light is unable to harden when located between the individual connecting terminal segments.

The housings of the connecting terminal segments advantageously have a base surface and four bordering lateral surfaces, and when the connecting terminal segments are connected, the base surface of the next connecting terminal segment seals the preceding connecting terminal segment. Thus the segments are designed to be open on one side, so that, after the housing is manufactured, it can be furnished with the terminal devices, i.e., the contact element, clamping elements, and/or connecting pins or connecting surfaces. After the connecting terminal segments are assembled to form a multi-polar connecting terminal, the individual housings of the connecting terminal segments are securely sealed. Thus the housing for the connecting terminal segments permits a simple and cost-effective manner of production.

The invention is next described in greater detail on the basis of the figures. Shown are:

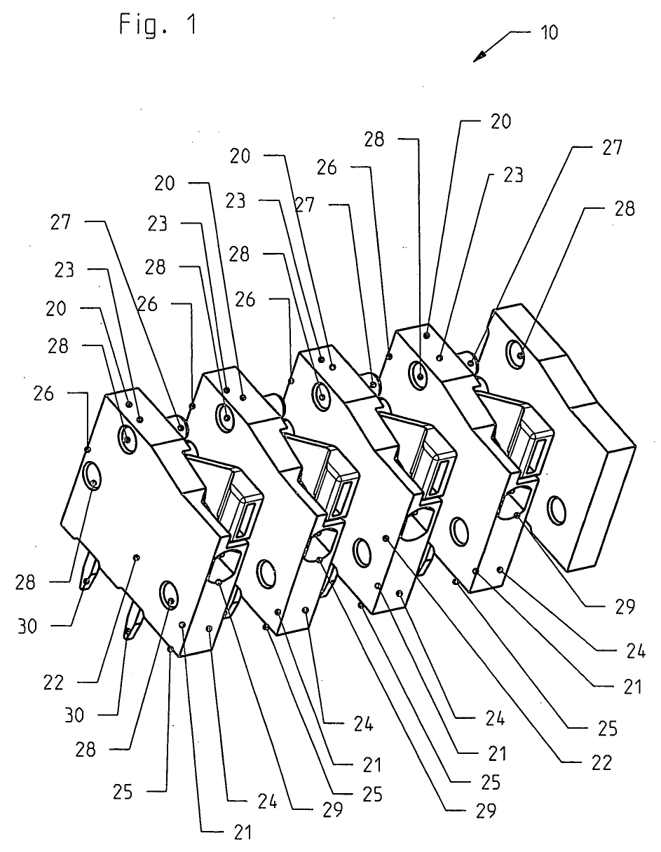

FIG. 1 an exploded view of a multi-polar connecting terminal, with a plurality of single-pole connecting terminal segments

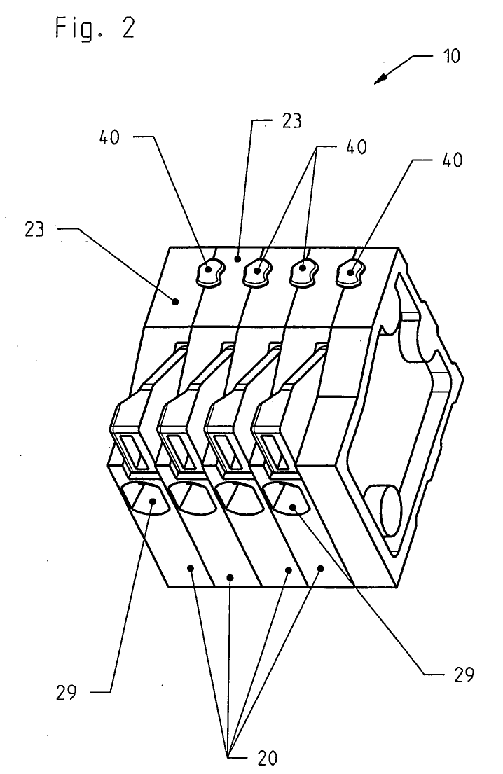

FIG. 2 the connecting terminal of FIG. 1 in assembled condition, showing the gluing points

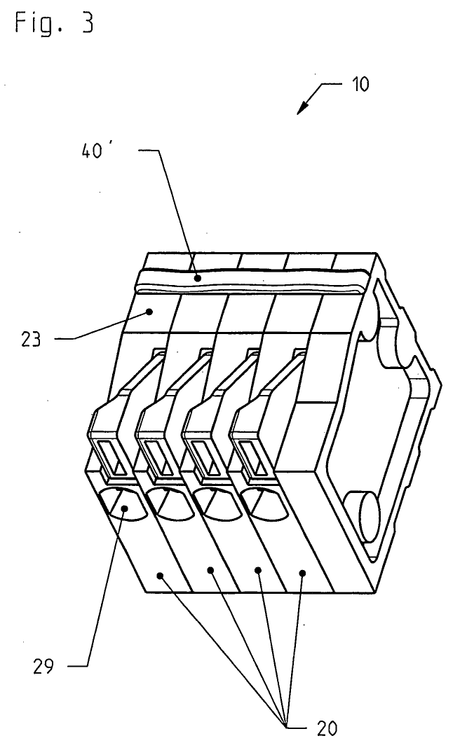

FIG. 3 the connecting terminal of FIG. 1 in assembled condition, showing an applied adhesive layer

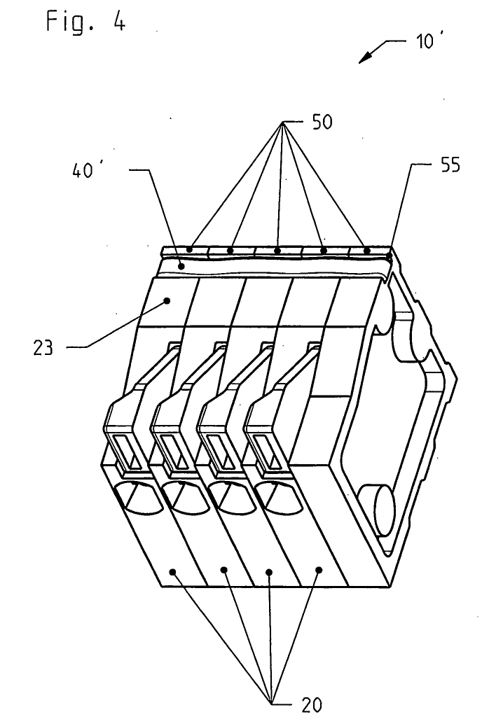

FIG. 4 an alternative embodiment of the connecting terminal of FIG. 1, showing an applied adhesive layer

FIG. 1 depicts the connecting terminal 10, which is composed of a plurality of connecting terminal segments 20. The connecting terminal segments 20 are all identical in construction, and each has a housing 21 with a base surface 22 and four bordering lateral areas 23, 24, 25, 26, such that the lateral areas 23, 24, 25, 26 are positioned at right angles to the base surface. The housing 21 is designed to be open on one side, so that it can be provided with the connecting devices appropriate for a single-pole connecting terminal after the housing is manufactured. For example, a contact element, a clamping spring, and connecting pins or connecting surfaces, can be inserted into the interior of the housing 21. It can be seen in FIG. 1 that two connecting pins 30 project downwards from the lateral area 25; by means of these two connecting pins 30 the connecting terminal segments 20 can be connected to a circuit board and soldered into position. Positioned in the lateral surface 24 is an insertion hole 29 for introducing an electrical conductor.

On the outside of the base surface 22 of housing 21 there are positioned a number of recesses 28 into which pegs 27, which project from the side of the housings 21 opposite the base surface 22, can engage in form-fitting manner. The pegs 27 and the recesses 28 thus form a plug-in or click-in mechanism by means of which two adjacent connecting terminal segments 20 can be joined. When two adjacent connecting terminal segments 20 are connected, the base surface 22 of the housing 21 of one of the connecting terminal segments 20 closes off the still open side of the housing 21 of the other connecting terminal segment 20, so that the locking mechanism of the connecting terminal is reliably positioned inside the housing 21 of connecting terminal segment 20. When the desired number of connecting terminal segments 20 is joined, the still open lateral area of the final connecting terminal segment 20 can be closed with a specially designed sealing component.

FIG. 2 shoes the connecting terminal 10 of FIG. 1 in assembled condition. To prevent deformation of the connecting terminal 10 when there is a high mechanical and/or thermal load, the connecting terminal segments 20 are additionally glued together. To this end, an adhesive layer 40 is applied to the contact area between adjacent connecting terminal segments 20, on the lateral surface 23 of the housing 21 of the connecting terminal segments 20. This adhesive layer 40 is formed by a number of individual gluing points on the individual contact areas. A single gluing point runs across the contact area, or contact seam, between two adjacent connecting terminal segments 20 and on the lateral surfaces 23 of the housing 21 of the corresponding connecting terminal segments 20. Even if the plug-in or click-in connection between the pegs 27 and the recesses 28 became slightly loosened under a high mechanical and/or thermal load, the gluing points would ensure a reliable connection between the individual connecting terminal segments 20. The adhesive layer 40 here is only applied on the outer surface of the connecting terminal 10 formed by the lateral areas 23, so that it can still be applied after the connecting terminal 10 is produced. In addition, there is no glue in the intermediate space between the connecting terminal segments 20, so that, e.g., the glue of the adhesive layer 40 can be a UV-hardening light. In particular, the glue of the adhesive layer 40 is temperature-stable, to permit the creation of a connection between the connecting terminal segments 20 that is reliable even under a high thermal load.

FIG. 3 shows the connecting terminal 10 of figure in assembled condition. Here, however, instead of the adhesive layer 40 comprising individual gluing points, there is an adhesive layer 40′, designed as an adhesive tape or strip, that is applied across the outside of the connecting terminal, as formed by the lateral areas 23 of the housings 21 of the connecting terminal segments 20. This adhesive strip can be applied in a single work-step. An adhesive tape, for example, one made of fabric, can also be applied in a simple single work-step, in order to reliably join the connecting terminal segments 20. In this embodiment the glue of the adhesive layer 40′ is also made with a temperature-stable base which hardens in UV light.

FIG. 4 shows an alternative embodiment of the connecting terminal 10′ of FIG. 1, in assembled condition. This example differs from the embodiment shown in FIG. 3 only in that a groove 50 runs in the lateral areas 23 of the housings 21 of the connecting terminals segments 20. This groove 50 is so positioned that the grooves 50 of the various connecting terminal segments 20 join to form a single groove 55 when the connecting terminal segments are combined, and this single groove 55 runs in transverse fashion across the lateral surface of the connecting terminal 10′, as formed by the lateral surfaces 23 of the housings 21 of the connecting terminal segments 20. The adhesive layer 40′, which is designed in particular as an adhesive tape or strip, is inserted into this groove 55, and the design is advantageous in that said adhesive layer 40′ does not build up on the lateral area 23 and can lie flush with the surface of the lateral area 23, in order to form a basically flat lateral area 23.

### List of Reference Numerals

10 connecting terminal
10′ connecting terminal
20 connecting terminal segment
21 housing
22 base surface
23 lateral surface
24 lateral surface
25 lateral surface
26 lateral surface
27 peg
28 recess
29 insertion hole
39 connecting pin
40 adhesive layer
40′ adhesive layer
50 groove
55 groove

1. Multi-polar connecting terminal (10, 10′), having a plurality of single-pole connecting terminal segments (20), each with a housing, such that the single-pole connecting terminal segments (20) can be joined together by a plug-in or click-in connection (27, 28) to form the multi-polar connecting terminal (10, 10′), wherein
the housings (21) of the connecting terminal segments (20) are glued together with an adhesive layer (40, 40′).

2. Connecting terminal according to claim 1, wherein
the adhesive layer (40, 40′) is produced from a liquid adhesive.

3. Connecting terminal according to claim 1, wherein
the adhesive layer (40, 40′) is formed by an adhesive tape, particularly an adhesive tape made of fabric.

4. Connecting terminal according to claim 1,
wherein
the adhesive layer (40, 40′) is only applied to the outside of the connecting terminal.

5. Connecting terminal according to claim 1,
wherein
the adhesive layer (40) is applied to the contact area between two connecting terminal segments that border each other.

6. Connecting terminal according to claim 1,
wherein
the adhesive layer (40′) is positioned in continuous fashion over an exterior surface of the connecting terminal (10, 10′) formed by the housing sides (23) of the individual connecting terminal segments (20).

7. Connecting terminal according to claim 1,
wherein
the housings (21) of the connecting terminal segments (20) each have a groove (50), which join to form a single groove (55) running across the connecting terminal (10′) when the connecting terminal segments are combined to form said connecting terminal (10′), and the adhesive layer (40) is inserted into the groove (55).

8. Connecting terminal according to claim 1,
wherein
the adhesive layer (40, 40′) uses a temperature-stable adhesive.

9. Connecting terminal according to claim 1,
wherein
the adhesive layer (40, 40′) uses a UV-hardening adhesive.

10. Connecting terminal according to claim 1,
wherein
the housings (21) for the connecting terminal segments (20) have a base surface (22) and four lateral surfaces (23, 24, 25, 26) that border said base surface (22), and when the connecting terminal segments (20) are combined, the base surface (22) of any given connecting terminal segment (20) seals the preceding connecting terminal segment (20).
